(19) United States
(12) Patent Application Publication
(10) Pub. No.: US 2014/0082465 A1
(43) Pub. Date: Mar. 20, 2014

(54) METHOD AND APPARATUS FOR GENERATING IMMERSIVE-MEDIA, MOBILE TERMINAL USING THE SAME

(71) Applicant: Electronics and Telecommunications Research Institute, Daejeon (KR)

(72) Inventors: Deock Gu JEE, Daejeon (KR); Mi Ryong PARK, Suwon (KR); Hyun Woo OH, Daejeon (KR); Jae Kwan YUN, Daejeon (KR); Mi Kyong HAN, Daejeon (KR); Ji Yeon KIM, Daejeon (KR); Jong Hyun JANG, Daejeon (KR); Kwang Roh PARK, Daejeon (KR)

(21) Appl. No.: 13/905,974

(22) Filed: May 30, 2013

(30) Foreign Application Priority Data
Sep. 14, 2012 (KR) 10-2012-0102318

(51) Int. Cl. G06F 17/24

(52) U.S. Cl. CPC G06F 17/24
USPC 715/202

(57) ABSTRACT

A method and apparatus for generating immersive media and a mobile terminal using the method and apparatus is disclosed. An apparatus for generating immersive media comprises an image generation unit generating image data based on image signals, a sensory effect data generation unit generating sensory effect data by obtaining information related to a sensory effect for providing a sensory effect in conjunction with the image data, and an immersive media generation unit generating immersive media based on the sensory effect data.

### CROSS-REFERENCE TO RELATED APPLICATIONS

This application claims the benefit of priority of Korean Patent Application No. 10-2012-0102318 filed on Sep. 14, 2012, all of which is incorporated by reference in its entirety herein.

### BACKGROUND OF THE INVENTION

1. Field of the invention

The present invention relates to a method and apparatus for generating immersive media and a mobile terminal using the method and apparatus. More particularly, the present invention relates to a method and apparatus for generating immersive media by obtaining information related to sensory effects at the time of image capture and a mobile terminal using the method and apparatus.

2. Related Art

Mobile terminals in the market today such as smart phones, tablet PCs, notebooks, PMPs, PDAs, and so on are equipped with various sensors in addition to a communication and camera module. For example, a mobile terminal is being equipped with an orientation detection sensor, accelerometer, gravity sensor, illumination sensor, GPS sensor, and the like. Also, a mobile terminal can be controlled by using a voice recognition function.

Therefore, a mobile terminal today can further obtain information related to a sensory effect which can increase a sense of reality, immediacy, and immersion by using various sensors in addition to capturing simple images by using a camera module. Furthermore, a mobile terminal today can generate immersive media based on the information related to sensory effects and the information can be stored in the mobile terminal or transmitted to other devices. The immersive media can be realized through a reproduction apparatus such as a vibrator, illumination device, motion chair, odor emitting device, and so on, thereby maximizing the sense of reality, immediacy, and immersion.

Conventional immersive media, intended to be played in a 4D movie theater or experience museum, are produced by experts in such a way of adding sensory effects to pre-recorded image contents and generating immersive media in a mobile terminal has not been attempted yet. Therefore, there is a demand for a method for generating immersive media including various pieces of information related to sensory effects at the time of image capture.

### SUMMARY OF THE INVENTION

The present invention has been made in an effort to provide a method and apparatus for generating immersive media by obtaining information related to sensory effects at the time of image capture.

The present invention has been made in an effort to provide a method and apparatus for generating immersive media by obtaining information related to sensory effects in real-time while images are being taken in a mobile terminal

According to one embodiment of the present invention, an apparatus for generating immersive media comprises an image generation unit generating image data based on image signals, a sensory effect data generation unit generating sensory effect data by obtaining information related to a sensory effect for providing a sensory effect in conjunction with the image data, and an immersive media generation unit generating immersive media based on the sensory effect data, where the sensory effect data generation unit generates the sensory effect data including at least one of sensory effect data related to an image obtained from the image signals, sensory effect data based on annotation information obtained from a user, sensor-related sensory effect data obtained from sensing signals detected by a sensor module, sensory effect data based on environment information obtained from the web, and sensory effect data related to sound obtained from sound signals.

The sensory effect data generation unit comprises an image sensory effect extraction unit generating sensory effect data related to the image compliant with the image context based on the image signals; a sound sensory effect extraction unit extracting a sound characteristic pattern based on the sound signals and generating sensory effect data related to the sound corresponding to the detected sound characteristic pattern; an annotation generation unit generating sensory effect data based on the annotation information based on the user's voice command; a sensor sensory effect extraction unit obtaining sensing signals detected by the sensor module and based on the obtained sensing signals, generating the sensor-related sensory effect data; an environment information generation unit obtaining environment information from the web through wireless communication and based on the obtained environment information, generating the environment information based sensory effect data; and a metadata conversion unit converting the sensory effect data including at least one of the image-related sensory effect data, sound-related sensory effect data, annotation-related sensory effect data, sensor-related sensory effect data, and environment information-related sensory effect data into metadata.

The annotation generation unit can comprise a voice recognition unit obtaining the voice command from the user and recognizing the voice command; and an annotation information extraction unit determining whether the voice command is an annotation command existing in a predefined annotation table and if the voice command corresponds to the annotation command, generating the annotation information-based sensory effect data based on the voice command.

The environment information generation unit can obtain the environment information including at least one piece of weather information from among temperature, humidity, wind, and the amount of rainfall corresponding to a predetermined time and location from the web.

The sensor module can include at least one of an orientation detection sensor, gravity sensor, accelerometer, illumination sensor, GPS sensor, ultraviolet sensor, and temperature sensor.

The image generation unit can generate the image data by encoding the image signals obtained by a camera module during image capture and the sound signals obtained by a microphone module.

A mobile terminal according to another embodiment of the present invention comprises a camera module obtaining image signals by capturing images; an image generation unit generating image data based on image signals; a sensory effect data generation unit generating sensory effect data by obtaining information related to a sensory effect for providing a sensory effect in conjunction with the image data; and an immersive media generation unit generating immersive media based on the sensory effect data, where the sensory effect data generation unit generates the sensory effect data including at least one of sensory effect data related to an image obtained from the image signals, sensory effect data based on annotation information obtained from a user, sensor-related sensory effect data obtained from sensing signals detected by a sensor module, sensory effect data based on environment information obtained from the web, and sensory effect data related to sound obtained from sound signals.

A method for generating immersive media according to another embodiment of the present invention comprises generating image data based on image signals, generating sensory effect data by obtaining information related to a sensory effect for providing a sensory effect in conjunction with the image data, and generating immersive media based on the sensory effect data, where the sensory effect data includes at least one of sensory effect data related to an image obtained from the image signals, sensory effect data based on annotation information obtained from a user, sensor-related sensory effect data obtained from sensing signals detected by a sensor module, sensory effect data based on environment information obtained from the web, and sensory effect data related to sound obtained from sound signals.

The annotation information-based sensory effect data can be generated based on the voice command if the voice command is obtained from the user and recognized; the recognized voice command is determined to correspond to an annotation command existing in a predefined annotation table; and the voice command is the annotation command.

The environment information-based sensory effect data can be generated based on environment information obtained from the web through wireless communication.

The environment information can include at least one piece of weather information from among temperature, humidity, wind, and the amount of rainfall corresponding to a predetermined time and location.

The sensor module can include at least one of an orientation detection sensor, gravity sensor, accelerometer, illumination sensor, GPS sensor, ultraviolet sensor, and temperature sensor.

The image-related sensory effect data can include a sensory effect compliant with image context based on the image signals.

The sound-related sensory effect data can include a sound sensory effect data corresponding to a sound characteristic pattern detected from the sound signals.

The image data can be generated by encoding the image signals obtained by a camera module during image capture and the sound signals obtained by a microphone module.

A method for generating immersive media in a mobile terminal according to yet another embodiment of the present invention comprises capturing images by using a camera module, generating image data based on image signals obtained by the camera module, generating sensory effect data by obtaining sensor effect-related information for providing a sensory effect in conjunction with the image data, and generating immersive media based on the image data and the sensor effect data, where the sensor effect data includes at least one of sensory effect data related to images obtained from the image signals, sensory effect data based on annotation information obtained from a user, sensor-related sensory effect data obtained from sensing signals detected by a sensor module, sensory effect data based on environment information obtained from the web, and sensory effect data related to sound obtained from sound signals.

### BRIEF DESCRIPTION OF THE DRAWINGS

FIG. 1 is a block diagram of a mobile terminal for generating immersive media according to one embodiment of the present invention.

FIG. 2 illustrates a user interface for generating immersive media according to one embodiment of the present invention.

FIG. 3 is a flow diagram illustrating a method for generating immersive media according to one embodiment of the present invention.

### DESCRIPTION OF EXEMPLARY EMBODIMENTS

In what follows, embodiments of the present invention will be described in detail with reference to appended drawings for those skilled in the art to which the present invention belongs to perform the present invention. The present invention is not limited to embodiments described below but can be applied in various other forms within the technical scope of the present invention.

Depending on the needs, constituting elements of the present invention can include additional elements not described in this document; detailed descriptions will not be provided for those elements not directly related to the present invention or overlapping parts thereof. Disposition of each constituting element described in this document can be adjusted according to the needs; one element can be incorporated into another element and similarly, one element can be divided into two or more elements.

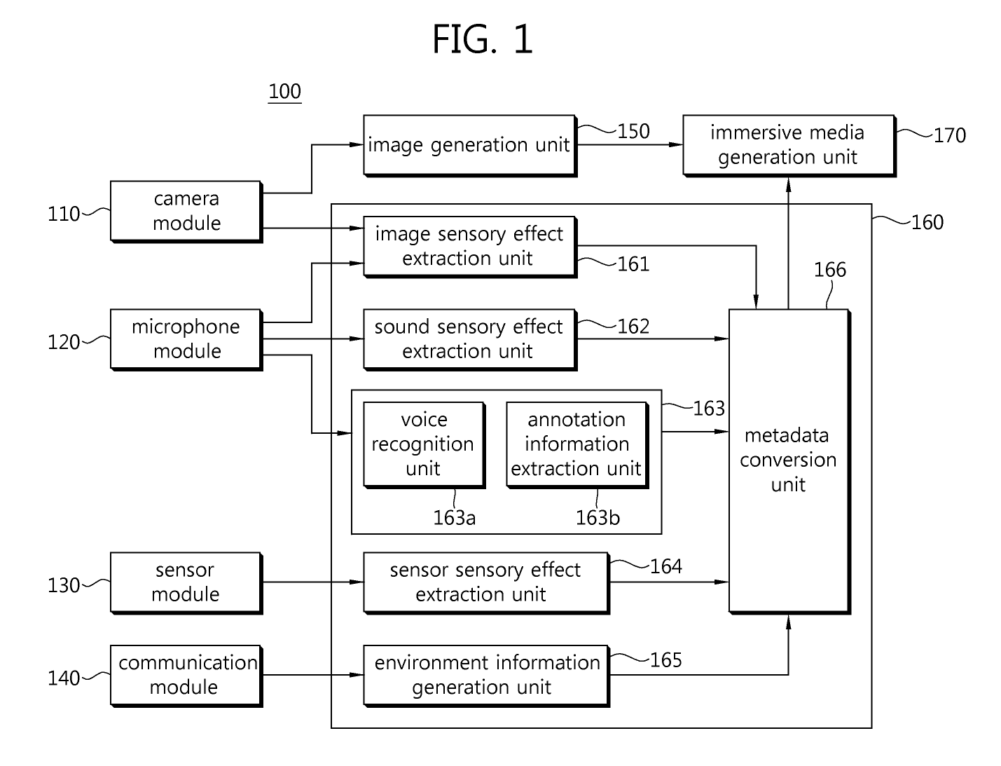

FIG. 1 is a block diagram of a mobile terminal for generating immersive media according to one embodiment of the present invention.

With reference to FIG. 1, a mobile terminal 100 comprises a camera module 110, a microphone module 120, a sensor module 130, a communication module 140, an image generation unit 150, a sensory effect data generation unit 160, and an immersive media generation unit 170.

The camera module 110 captures an image by using a CCD (Charge-Coupled Device) camera or CMOS (Complementary Metal-Oxide-Semiconductor) camera and obtains image signals by converting captured images into electric signals.

The microphone module 120, being equipped with a microphone, recognizes a sound coming through the microphone and obtains sound signals by converting the recognized sound into electric signals.

The sensor module 130 obtains at least one piece of sensing information by using at least one sensor. For example, the sensor module 130 can be equipped with at least one of an orientation detection sensor, gravity sensor, accelerometer, illumination sensor, GPS sensor, ultraviolet sensor, and temperature sensor; and can obtain a sensing signal from each of the individual sensors.

The communication module 140, being equipped with a communication interface, supports wireless communication (for example, WiFi, WiBro, WiMAX, Mobile WiMAX, LTE, and so on). For example, the communication module 140, being connected to a wireless communication network by a communication interface, can use a web service.

The image generation unit 150 generates image data based on image and sound signals obtained at the time of image capture. For example, while images are captured by using the mobile terminal 100, image data can be generated by encoding image signals obtained from the camera module 110 and sound signals obtained from the microphone module 120.

The sensory effect data generation unit 160 generates sensory effect data by obtaining sensory effect-related information meant for providing a sensory effect in conjunction with the image data generated by the image generation unit 150.

The sensory effect data includes at least one of sensory effect data related to an image obtained from the image signals, sensory effect data based on annotation information obtained from a user, sensor-related sensory effect data obtained from sensing signals detected by a sensor module, sensory effect data based on environment information obtained from the web, and sensory effect data related to sound obtained from sound signals.

More specifically, the sensory effect data generation unit 160 comprises an image sensory effect extraction unit 161, sound sensory effect extraction unit 162, annotation generation unit 163, sensor sensory effect extraction unit 164, environment information generation unit 165, and metadata conversion unit 166.

The image sensory effect extraction unit 161 extracts necessary information by analyzing images based on image signals obtained from the camera module 110 and based on the extracted information, generates a motion effect compliant with the image context and/or image-related sensory effect data such as a lighting effect.

For example, in case a photographer riding a roller coaster takes a picture, a sensory effect data is generated by extracting a motion effect while in case fireworks are captured, a sensory effect data is generated by extracting a lighting effect corresponding to the color and brightness of fireworks is extracted. A motion effect can be obtained by either extracting a motion of a particular object within an image or extracting movement of a background image according to the camera movement. The lighting effect can be extracted by analyzing the color and brightness of pixels within an image.

The sound sensory effect extraction unit 162 extracts a sound characteristic pattern based on a sound signal obtained from the microphone module 120 and generates sound-related sensory effect data corresponding to the detected sound characteristic pattern.

To this purpose, the sound sensory effect extraction unit 162 detects a sound characteristic pattern by analyzing frequency component, pitch, period, MFCC (Mel Frequency Cepstral Coefficient), and so on of a sound signal. The detected sound characteristic pattern can be recognized by using a predefined sound characteristic pattern table and as a recognition result, a sensory effect such as a vibration effect, water jet effect, wind effect, and so on corresponding to the sound characteristic pattern is extracted to generate a sound-related sensory effect data.

For example, if vibration characteristics are extracted from a sound signal, a vibration effect due to sound can be generated whereas if a sound characteristic pattern of a sound of water streaming from a fountain is extracted, a water jet effect can be generated. Similarly, if a sound characteristic pattern about a sound of wind and wind strength is extracted, a wind effect can be generated.

The annotation generation unit 163 generates annotation information based sensory effect data from a voice command of the user. To this purpose, the annotation generation unit 163 comprises a voice recognition unit 163a and annotation information extraction unit 163b.

The voice recognition unit 163a obtains a voice command of the user through the microphone module 120 and recognizes the voice command.

For example, in case the user wants to generate a sensory effect directly during image capture, he or she can issue a voice command by using an independent word or successive words. At this time, if the user's voice command is delivered to the voice recognition unit 163a through the microphone module 120, the voice recognition unit 163a can recognize a voice command comprising an independent word or successive words.

The annotation information extraction unit 163b generates annotation information-based sensory effect data based on a voice command recognized by the voice recognition unit 163a. In other words, it is determined whether a voice command recognized by the voice recognition unit 163a corresponds to an annotation command existing in a predefined annotation table. As a recognition result, if the voice command is an annotation command, annotation information-based sensory effect data is generated based on the voice command of the user.

For example, in case the words recognized by the voice recognition unit 163a constitute a sequential order of voice commands such as “wind”, “effect”, “start”, “intensity 3”, and “end”, the annotation information extraction unit 163b determines whether an annotation command of “wind” exists in the annotation table. If there exists an annotation command corresponding to “wind”, a wind effect annotation can be generated. Also, the annotation information extraction unit 163b can add to the wind effect annotation the information about start and end time of a wind effect by using time information when the voice command “start” and “end” are received; and information about intensity of wind (strength) by using the voice command of “intensity 3”.

The annotation information-based sensory effect data according to the present invention is intended for supporting easy addition of sensory effect-related information which cannot be readily obtained from an image signal, sound signal, sensing signal, and the like. The annotation information-based sensory effect data enables the user to insert a sensory effect suitable for image data different from a conventional image data-based annotation generation method which employs a semantic analysis of image data but describes only simple information about the image data. Therefore, the annotation information-based sensory effect data can provide much more various sensory effects than the sensory effect information extracted through a simple analysis of image data.

Also, since mobile terminals are designed to have a small size for portability in most cases, it is somewhat difficult for the user to generate an annotation by operating the mobile terminal during image capture. On the other hand, a method for generating an annotation according to the present invention utilizes a voice command; therefore, the user of a mobile terminal can generate annotations more easily for generation of immersive media.

The sensor sensory effect extraction unit 164 generates sensor-related sensory effect data based on sensing signals obtained by the sensor module 130.

For example, the motion of a mobile terminal during image capture or the motion of the user who uses the mobile terminal can be detected in the form of a sensing signal by the sensor module 130 such as an orientation detection sensor, gravity sensor, accelerometer, and the like. Such a sensing signal is delivered to a sensor sensory effect extraction unit 164 and the sensor sensory effect extraction unit 164 generates sensor-related sensory effect data such as a three-dimensional motion effect in accordance with the sensing signal. For example, temperature information measured by a temperature sensor is delivered to the sensor sensory effect extraction unit 164 and the sensor sensory effect extraction unit 164 generates a sensor-related sensory effect data such as a heater effect or a wind effect based on the temperature information.

The environment information generation unit 165 obtains environment information from the web through wireless communication and based on the obtained environment information, generates environment information-based sensory effect data. For example, the environment information generation unit 165, being connected to a wireless communication network, can use a web service and obtain information by searching the web for the information required.

Environment information-based sensory effect data, in addition to the aforementioned image-related sensory effect data, sound-related sensory effect data, annotation information-based sensory effect data, and sensor-related sensory effect data, is generated by obtaining environment information from the web as an additional sensory effect which can be obtained through a web search, where the information can include weather information such as temperature, humidity, wind, the amount of rainfall, and so on.

For example, the web can provide environment information such as temperature, humidity, wind, the amount of rainfall, and the like corresponding to capture time and location at which an image is captured by the mobile terminal 100; current location and time; or particular location and time of the mobile terminal 100. The received environment information can be mined so that it can be combined in association with an image signal, sound signal, sensing signal, and so on. Information about time and location can be obtained by using a GPS sensor installed in the mobile terminal 100 or base station information of the mobile terminal 100.

The metadata conversion unit 166 converts sensor effect data including at least one of the image-related sensory effect data, sound-related sensory effect data, annotation information-based sensory effect data, sensor-related sensory effect data, and environment information-based sensory effect data into metadata. At this time, the sensory effect data can be converted into metadata with reference to technical specifications such as the MPEG-V (MPEG for Virtual world).

The MPEG-V defines interface specifications between a virtual and real world and a communication interface between the virtual and real world, including various technical specifications ranging from representation of sensory effects such as wind, temperature, vibration, and the like to representation of avatars and virtual objects, and control command descriptions for associating the virtual world and devices.

Table 1 illustrates syntax by which a wind effect according to one embodiment is expressed as metadata with reference to the technical specifications of the MPEG-V.

```
TABLE 1
<!-- ################################################ -->
  <!-- SEV Wind type  -->
  <!-- ################################################ -->
  <complexType name=“WindType”>
    <complexContent>
      <extension base=“sedl:EffectBaseType”>
        <attribute name=“intensity-value”
        type=“sedl:intensityValueType”
          use=“optional”/>
        <attribute name=“intensity-range”
        type=“sedl:intensityRangeType”
          use=“optioal”/>
      </extension>
    </complexContent>
  </complexType>
```

The immersive media generation unit 170 generates immersive media based on sensory effect data generated by the image data generated by the image generation unit 150 and the sensory effect data generated by the sensory effect data generation unit 160.

At this time, the image data and sensory effect data can be multiplexed into a single file to form immersive media or the image data and sensory effect data can form immersive media as separate files.

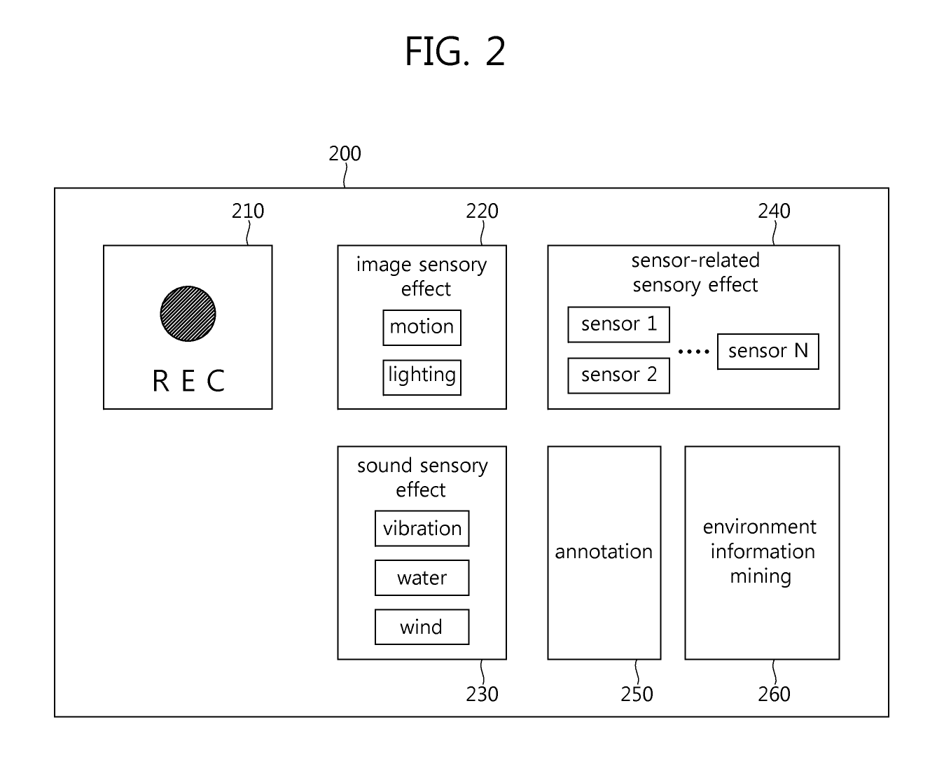

FIG. 2 illustrates a user interface for generating immersive media according to one m embodiment of the present invention.

In case immersive media is generated by using a mobile terminal such as a mobile phone, smart phone, table PC, notebook, PMP, PDA, and so on, it is important to design a user interface in such a way that the user can operate the mobile terminal in a convenient and easy manner.

As shown in FIG. 2, the user interface 200 can include an image recording icon 210, image sensory effect icon 220, sound sensory effect icon 230, sensor-related sensory effect icon 240, annotation icon 250, and environment information mining icon 260.

At this time, each icon 210-260 is used to turn on or off the corresponding function of the icon by the user's operation thereof. For example, in case the function of the annotation icon 250 is set to ON by the user's operation, annotation information-based sensory effect data can be generated by the annotation generation unit 163 of FIG. 1 described above.

For example, if the user presses the image recording icon 210 for generating immersive media, a controller (not shown) starts control operation for generating immersive media according to ON/OFF set-up of the individual icons 210-260. At this time, since the camera module 110, microphone module 120, sensor module 130, and so on generates an image signal, sound signal, and sensing signal respectively according to the respective operating periods, the controller (not shown) carries out a synchronization function which synchronizes the individual signals generated from the respective modules with each other. And according to a control signal of the controller (not shown), the image sensory effect extraction unit 161, sound sensory effect extraction unit 162, annotation generation unit 163, sensor sensory effect extraction unit 164, and environment information generation unit 165 generate the corresponding sensory effect data, respectively.

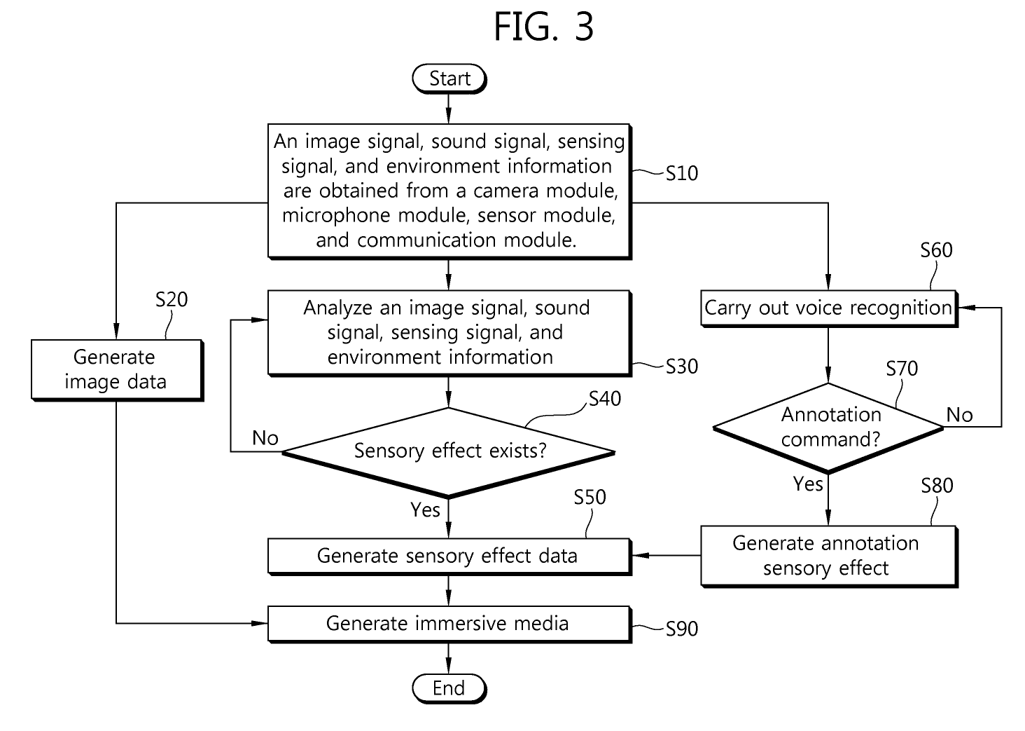

FIG. 3 is a flow diagram illustrating a method for generating immersive media according to one embodiment of the present invention. The method can be carried out by the mobile terminal 100 of FIG. 1.

With reference to FIG. 3, while the mobile terminal 100 captures an image by using the camera module 110, at least one of an image signal, sound signal, sensing signal, and environment information is obtained from at least one of the camera module 110, microphone module 120, sensor module 130, and communication module 140 installed in the mobile terminal 100, S10.

The mobile terminal 100 generates image data based on an image signal obtained by the camera module 110 and a sound signal obtained by the microphone module 120, S20. The above process can be carried out by the image generation unit 150 of the mobile terminal 100 and the image generation unit 150 can generate image data by encoding the image signal and sound signal.

The mobile terminal 100 analyzes at least one of the image signal, sound signal, sensing signal, and environment information obtained S30 and determines from the analyzed image signal, sound signal, sensing signal, and environment information whether there exists a sensory effect related information for providing a sensory effect in conjunction with the image data S40. If sensory effect related information exists as a determination result, sensory effect data is generated S50. The steps of S30-S50 can be carried out by a sensory effect data generation unit 160 of the mobile terminal 100.

For example, the sensory effect data generation unit 160 analyzes an image signal obtained by the camera module 100 and if there exists an image-related sensory effect such as a motion effect, lighting effect, and the like compliant with the image context, image-related sensory effect data can be generated.

Similarly, the sensory effect data generation unit 160 analyzes a sound signal obtained by the microphone module 120 and extracts a sound characteristic pattern and if the detected sound characteristic pattern exists in a predefined sound characteristic pattern table, sound-related sensory effect data corresponding to the sound characteristic pattern can be generated.

Also, the sensory effect data generation unit 160 analyzes a sensing signal obtained by the sensor module 130 and if there exists a sensor-related sensory effect such as a motion effect, heater effect, wind effect, and so on compliant with the sensing signal, the sensor-related sensory effect data can be generated.

In addition, the sensory effect data generation unit 160 obtains and analyzes weather information such as temperature, humidity, wind, the amount of rainfall, and the like corresponding to the location and time of the mobile terminal 100 at the time of image capture by communicating with the web through the communication module 140, thus generating environment information-based sensory effect data.

Meanwhile, voice recognition is carried out in the step S10 based on a sound signal obtained by the microphone module 120, S60 and it is determined whether the recognized voice is an annotation command S70. If it is found to be an annotation command as a determination result, annotation information-bases sensory effect data is generated based on the recognized voice S80. The steps of S60 to S80 can be carried out by the sensory effect data generation unit 160 of the mobile terminal 100.

For example, the sensory effect generation unit 160 carries out voice recognition of the user from a sound signal obtained by the microphone module 120. And it is determined whether the recognized voice exists in a predefined annotation table. If the recognized voice is an annotation command existing in the annotation table, annotation information corresponding to the command can be generated.

As described above, the sensory effect data generated based on an image signal, sound signal, sensing signal, environment information, and the user's voice command can include at least one of image-related sensory effect data, sound-related sensory effect data, sensor-related sensory effect data, environment information-based sensory effect data, and annotation information-based sensory effect data. Such sensory effect data can be converted into metadata by incorporating time information thereto.

Meanwhile, the mobile terminal 100 generates immersive media by combining image data and sensor effect data S90. The generated immersive media can be carried out by the immersive media generation unit 170 of the mobile terminal 100.

The mobile terminal according to the embodiments of the present invention described above may correspond to a mobile phone, smart phone, tablet PC, notebook, PMP, PDA, and the like. Also, a mobile terminal capable of generating immersive media according to the present invention can automatically extract sensory effect-related information by analyzing a captured image signal, sound signal, and sensing signal without incorporating particular operation of the terminal during image capture; and can generate various sensory effects more easily by generating an annotation from the voice command of the user. Also, the mobile terminal capable of generating immersive media according to the present invention can automatically extract environment information by using a web search. Therefore, the mobile terminal according to the present invention can generate immersive media in real-time at the same time images are taken.

According to the present invention, sensory effect-related information can be obtained at the same time of image capture by using a mobile terminal without employing a separate device for generating immersive media. Also, an annotation function with which a user can directly generate sensory effect-related information based on the user's voice command during image capture can be provided and additional sensory effect can be generated by obtaining various pieces of information by using a web search. Therefore, the user can generate immersive media in a more convenient and easier manner and generate immersive media in real-time at the same time of image capture.

In the embodiments described above, although methods have been described through a series of steps or a block diagram, the present invention is not limited to the order of steps and some step can be carried out in a different order and as a different step from what has been described above or some step can be carried out simultaneously with other steps. Also, it should be understood by those skilled in the art that those steps described in the flow diagram are not exclusive; other steps can be incorporated to those steps; or one or more steps of the flow diagram can be removes without affecting the technical scope of the present invention.

Descriptions of this document are just examples to illustrate the technical principles of the present invention and various modifications are possible for those skilled in the art to which the present invention belongs without departing from the scope of the present invention. Therefore, the embodiments disclosed in this document are not intended for limiting but for describing the technical principles of the present invention; therefore, the technical principles of the present invention are not limited by the embodiments disclosed in this document. The scope of the present invention should be defined by appended claims and all the technical principles within the equivalent of the scope defined by the appended claims should be interpreted to belong to the technical scope of the present invention.

What is claimed is:

1. An apparatus for generating immersive media, comprising:
an image generation unit generating image data based on image signals;
a sensory effect data generation unit generating sensory effect data by obtaining information related to a sensory effect for providing a sensory effect in conjunction with the image data; and
an immersive media generation unit generating immersive media based on the sensory effect data,
where the sensory effect data generation unit generates the sensory effect data including at least one of sensory effect data related to an image obtained from the image signals, sensory effect data based on annotation information obtained from a user, sensor-related sensory effect data obtained from sensing signals detected by a sensor module, sensory effect data based on environment information obtained from the web, and sensory effect data related to sound obtained from sound signals.

2. The apparatus of claim 1, wherein the sensory effect data generation unit comprises an image sensory effect extraction unit generating sensory effect data related to the image compliant with the image context based on the image signals;
a sound sensory effect extraction unit extracting a sound characteristic pattern based on the sound signals and generating sensory effect data related to the sound corresponding to the detected sound characteristic pattern;
an annotation generation unit generating sensory effect data based on the annotation information based on the user's voice command;
a sensor sensory effect extraction unit obtaining sensing signals detected by the sensor module and based on the obtained sensing signals, generating the sensor-related sensory effect data;
an environment information generation unit obtaining environment information from the web through wireless communication and based on the obtained environment information, generating the environment information based sensory effect data; and
a metadata conversion unit converting the sensory effect data including at least one of the image-related sensory effect data, sound-related sensory effect data, annotation-related sensory effect data, sensor-related sensory effect data, and environment information-related sensory effect data into metadata.

3. The apparatus of claim 2, wherein the annotation generation unit comprises a voice recognition unit obtaining the voice command from the user and recognizing the voice command; and an annotation information extraction unit determining whether the voice command is an annotation command existing in a predefined annotation table and if the voice command corresponds to the annotation command, generating the annotation information-based sensory effect data based on the voice command.

4. The apparatus of claim 2, wherein the environment information generation unit obtains the environment information including at least one piece of weather information from among temperature, humidity, wind, and the amount of rainfall corresponding to a predetermined time and location from the web.

5. The apparatus of claim 2, wherein the sensor module includes at least one of an orientation detection sensor, gravity sensor, accelerometer, illumination sensor, GPS sensor, ultraviolet sensor, and temperature sensor.

6. The apparatus of claim 1, wherein the image generation unit generates the image data by encoding the image signals obtained by a camera module during image capture and the sound signals obtained by a microphone module.

7. A mobile terminal, comprising:
a camera module obtaining image signals by capturing images;
an image generation unit generating image data based on image signals;
a sensory effect data generation unit generating sensory effect data by obtaining information related to a sensory effect for providing a sensory effect in conjunction with the image data; and
an immersive media generation unit generating immersive media based on the sensory effect data,
where the sensory effect data generation unit generates the sensory effect data including at least one of sensory effect data related to an image obtained from the image signals, sensory effect data based on annotation information obtained from a user, sensor-related sensory effect data obtained from sensing signals detected by a sensor module, sensory effect data based on environment information obtained from the web, and sensory effect data related to sound obtained from sound signals.

8. A method for generating immersive media, comprising:
generating image data based on image signals;
generating sensory effect data by obtaining information related to a sensory effect for providing a sensory effect in conjunction with the image data; and
generating immersive media based on the sensory effect data,
where the sensory effect data includes at least one of sensory effect data related to an image obtained from the image signals, sensory effect data based on annotation information obtained from a user, sensor-related sensory effect data obtained from sensing signals detected by a sensor module, sensory effect data based on environment information obtained from the web, and sensory effect data related to sound obtained from sound signals.

9. The method of claim 8, wherein the annotation information-based sensory effect data is generated based on the voice command if the voice command is obtained from the user and recognized; the recognized voice command is determined to correspond to an annotation command existing in a predefined annotation table; and the voice command is the annotation command.

10. The method of claim 8, wherein the environment information-based sensory effect data is generated based on environment information obtained from the web through wireless communication.

11. The method of claim 10, wherein the environment information includes at least one piece of weather information from among temperature, humidity, wind, and the amount of rainfall corresponding to a predetermined time and location.

12. The method of claim 8, wherein the sensor module includes at least one of an orientation detection sensor, gravity sensor, accelerometer, illumination sensor, GPS sensor, ultraviolet sensor, and temperature sensor.

13. The method of claim 8, wherein the image-related sensory effect data includes a sensory effect compliant with image context based on the image signals.

14. The method of claim 8, wherein the sound-related sensory effect data includes a sound sensory effect data corresponding to a sound characteristic pattern detected from the sound signals.

15. The method of claim 8, wherein the image data is generated by encoding the image signals obtained by a camera module during image capture and the sound signals obtained by a microphone module.

16. A method for generating immersive media in a mobile terminal, comprising:
capturing images by using a camera module;
generating image data based on image signals obtained by the camera module;
generating sensory effect data by obtaining sensor effect-related information for providing a sensory effect in conjunction with the image data; and
generating immersive media based on the image data and the sensor effect data,
where the sensor effect data includes at least one of sensory effect data related to images obtained from the image signals, sensory effect data based on annotation information obtained from a user, sensor-related sensory effect data obtained from sensing signals detected by a sensor module, sensory effect data based on environment information obtained from the web, and sensory effect data related to sound obtained from sound signals.
